(19) United States
(12) Patent Application Publication
(10) Pub. No.: US 2003/0233480 A1
(43) Pub. Date: Dec. 18, 2003

(54) Apparatus for integrating voice and data communications

(75) Inventors: Chih-Jung Peng, Taipei (TW); Jun-Dah Chen, Taipei (TW)

Correspondence Address: NIXON PEABODY, LLP, 8180 GREENSBORO DRIVE, SUITE 800, MCLEAN, VA, 22102, US

(73) Assignee: SILITEK CORPORATION, Taipei (TW)

(21) Appl. No.: 10/287,483

(22) Filed: Nov. 5, 2002

(30) Foreign Application Priority Data
Mar. 29, 2002 (TW) 091106344

(51) Int. Cl. G06F 15/16

(52) U.S. Cl. 709/250; 709/249

(57) ABSTRACT

The present invention relates to an apparatus for integrating voice and data communications. The apparatus respectively electrically couples to a terminal device and a base station. The apparatus includes a wireless local area network module, a mobile communication network module, and an audio gateway. The wireless local area network module and the mobile communication network module transmit the voice signal and/or data signal to the terminal device and the base station.

### CROSS REFERENCE TO RELATED APPLICATIONS

This application claims priority to Taiwan Patent Application No. 091106344 entitled “Apparatus for Integrating Voice and Data Process”, filed Mar. 29, 2002.

### FIELD OF THE INVENTION

The present invention generally relates to an apparatus for integrating voice and data communications, and more specifically, to a personal digital assistant apparatus for integrating voice and data communications.

### BACKGROUND OF THE INVENTION

Personal digital assistant (PDA) is a small size hand-held electronic device. With functions analogous to a computer, now it is a first choice for handling personal daily miscellaneous works. The main function for PDA is like traditional paper notebook recording personal daily information, such as communication data, memos, notes, calendar, etc. Comparing to classic paper notebook, PDA stores huge amount of data, modifies data and searches data efficiently via digital technology. By implementing the highly efficient data base technology, users can manage their personal data efficiently.

With progress of technology, PDA is no longer limited to functions of voice recording, calendar, phone book, or calculator. With additional hardware accessories, PDA has added functions such as infrared wireless transmission, data synchronization process with computers, e-mails access via Internet, multimedia data replay, programming, and digital logic operations, etc. Therefore, PDA nowadays has so many applications.

A typical PDA can be connected to a cellular phone via a wire connection between ‘Universal Asynchronous Receiver/Transmitter Port’ and the cellular phone. Through communication between the cellular phone and base stations, users may use PDA to send or receive short messages or surf the webs. Also, PDA can be implemented with a GSM module to transmit data to and from mobile base stations, or use built-in bluetooth module for data transmission in short distances. However, all conventional methods mentioned above for PDA are only valid for data communication and handling, not for audio information.

### OBJECTS AND SUMMARY OF THE INVENTION

It is therefore an aspect of the present invention to provide an apparatus for integrating voice and data communications in a personal digital assistant (PDA). User can use the PDA cooperated with the present invention to wireless transmit voice and data signals. The present invention modulizes the PDA to integrate voice and data communications, which is cost reduction and operation convenience.

The present invention provides an apparatus for integrating voice and data transmissions in a PDA. The PDA includes an interface for communicating with the apparatus. The apparatus independently electrically couples to a terminal device and a base station. The apparatus includes a wireless local area network (WLAN) module, a mobile communication network (MCN) module, and an audio gateway. The wireless local area network module transmits a voice signal and/or a data signal to the terminal device, and further transmits the data signal to the PDA interface via a bus. The mobile communication network module transmits the voice signal and/or the data signal to the base station. The audio gateway controls the transmission of the voice signal between the wireless local area network module, the mobile communication network module, and the PDA interface.

The apparatus further includes a transceiver (or receiver/transmitter) and a central control unit. The transceiver, such as a universal asynchronous receiver/transmitter (UART), transmits the data signal to the PDA interface. The central control unit, such as a microcontroller, processes the data signal between the mobile communication network module and the universal asynchronous receiver/transmitter.

The apparatus further includes a network control unit interface for coupling the PDA with a fixed-line network telephone. The function of the network control unit interface is to receive a carrier signal. The carrier signal is then transmitted to the wireless local area network module via the audio gateway and to the terminal device via the wireless local area network module.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates one embodiment of the present invention;

FIG. 2 illustrates a flow diagram of the initial procedure of the PDA;

FIG. 3 illustrates a flow diagram of building up the voice-link connection of the PDA;

FIG. 4 illustrates a flow diagram of checking the interface of the PDA;

FIG. 5 illustrates a flow diagram of using the PDA to make a phone call in accordance with the present invention;

FIG. 6 illustrates a flow diagram of using the PDA to receive a phone call in accordance with the present invention;

FIG. 7 illustrates a flow diagram of using the PDA to send a short message in accordance with the present invention;

FIG. 8 illustrates a flow diagram of using the PDA to wirelessly access the internet in accordance with the present invention;

FIG. 9 illustrates a flow diagram of using the PDA to receive a call from the fixed-line network telephone in accordance with the present invention; and

FIG. 10 illustrates a flow diagram of using the PDA to receive a music file in MP3 format in accordance with the present invention.

### DETAILED DESCRIPTION OF THE INVENTION

The present invention provides an apparatus, which utilizes a wireless local area network module, a mobile communication network module, and a network control unit interface to transmit voice and data signals of a personal digital assistant wirelessly and interference free. The apparatus also provides the PDA a telephone interface. In the software aspect, the apparatus controls every control signal of each module such that the voice and data signals are correctly transmitted and processed even when any interruptions of the transmission is occurred.

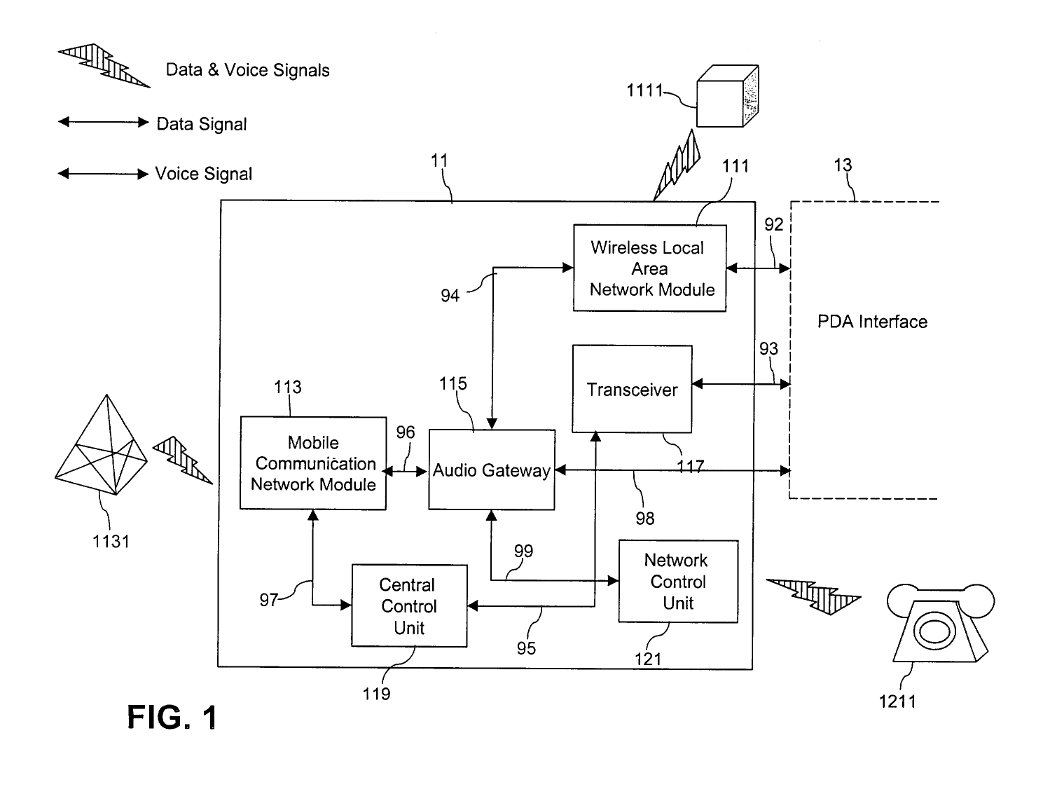

FIG. 1 illustrates an apparatus 11 of the present invention, which integrates a voice signal and/or a data signal in a personal digital assistant (PDA). The apparatus 11 includes a wireless local area network module 111, a mobile communication network module 113, an audio gateway 115, a transceiver 117, and a central control unit 119. The PDA wirelessly transmits a voice signal and a data signal to a terminal device 1111 via the wireless local area network module 111. The terminal device 1111 can be a printer, a personal computer, a bluetooth earphone, and the like. The wireless local area network module 111 can be an IEEE 802.11, a bluetooth module, and the like. For example, when the wireless local area network module 111 is a bluetooth module, the terminal device is a bluetooth earphone. With the application of the present invention, the user can receive or make a phone call and listen to music in MP3 format played by the PDA via the bluetooth earphone. The wireless local area network module 111 transmits the data signal to the PDA interface 13 through a bus 93, such as a universal serial bus (USB), UART, or a personal computer memory card international association (PCMCIA) bus.

The mobile communication network module 113 transmits the voice signal and/or data signal to a base station 1131. The mobile communication network module 113 can be a global system for mobile communication (GSM) module, a general packet radio service (GPRS) module, or a code-division multiple access (CDMA) module. The PDA receives or makes a phone call, sends a short message, and wirelessly accesses the internet through the mobile phone service provided by the GSM or GPRS system. In the apparatus 11, the audio gateway 15 controls the transmission of the voice signal between the wireless local area network module 111, the mobile communication network module 113, and the PDA interface 13. The voice signal is two-way transmitted between the wireless local area network module 111 and the audio gateway 115 via a transmission path 94. The voice signal is also two-way transmitted between the mobile communication network module 113 and the audio gateway 115 via a transmission path 96, and between the PDA and the audio gateway 115 via a transmission path 98. When the voice signal is transmitted to the audio gateway 115, the audio gateway 115 transmits the voice signal to the subsequent processing device.

Additionally, the apparatus 11 uses the transceiver 117 to transmit the data signal to the PDA interface 13. The data signal is two-way transmitted between the transceiver 117 and the PDA interface 13 via a transmission path 93. The transceiver 117 is generally a universal asynchronous receiver/transmitter (UART), which synchronously and asynchronously transmits or transforms the data signal. The apparatus 11 uses the central control unit 119 to process the data signal between the mobile communication network module 113 and the transceiver 117. The central control unit 119 is a microcontroller capable of operating and processing data, such as data communications, data management, data encryption/decryption. The data signal is two-way transmitted between the central control unit 119 and the transceiver 117 via a transmission path 95, and also two-way transmitted between the central control unit 119 and the mobile communication network module 119 via a transmission path 97.

The apparatus further provides a network control unit interface 121 for coupling the PDA to the fixed-line network telephone 1121. The network control unit interface 121 switches the carrier signal of the fixed-line network telephone 1121 to the PDA. Then, the terminal device 1111, such as the bluetooth earphone, receives the call. In other words, when the network control unit interface 121 receives the carrier signal of the fixed-line network telephone 1121, the carrier signal is transmitted to the audio gateway 115 via transmission path 99, then to the wireless local area network module 111, finally to the terminal device 1111.

For example, the PAD cooperates with the mobile communication network module 113 to receive the voice signal sent from a mobile communication base station 1131. The user determines what module, the wireless local area network module 111 or the PDA interface 13, to receive the voice signal. Then, the voice signal is transmitted to the designated destination via the audio gateway 115. When the user selects the wireless local network module 111, such as a bluetooth module, to receive the voice signal, the user uses the corresponding terminal device, such as a bluetooth earphone, to receive the voice signal.

Similarly, when the user selects the wireless local area network module 111 or the PDA interface 13 to transmit a voice signal, the voice signal is transmitted through the audio gateway 115 and the mobile communication network module 113 to the mobile communication base station 1131. Moreover, the user can uses the bluetooth module and the bluetooth earphone to receive a music file, such as a MP3 file, played by the PDA.

When the user selects the PDA interface 13 to transmit the data signal optionally through a bus 92, for example, a universal serial bus (USB), the data signal is transmitted from the wireless local area network module 111 to the terminal device 1111, such as a printer and a personal computer. When the user selects the PDA interface 13 to transmit the data signal through the transmission path 93, the data signal is transmitted to the transceiver 117, such as a UART, which synchronously and asynchronously transmits or transforms the data signal. Then, the data signal is transmitted through the transmission path 95 to the central control unit 119, such as a microcontroller. The central control unit 119 processes the data signal and transmits the data signal to the mobile communication network module 113 via the transmission path 97. Then, the mobile communication network module 13 transmits the data signal to the mobile communication base station 1131.

Similarly, the PDA can use the wireless local area network module 111 to receive a data signal from the terminal device 1111. The data signal is transmitted through the bus 92 to the PDA interface 13. Moreover, the PDA can use the mobile communication network module 113 to receive the data signal from the mobile communication base station 1131. The data signal is transmitted to the PDA interface 13 through the central control unit 119 and the transceiver 117.

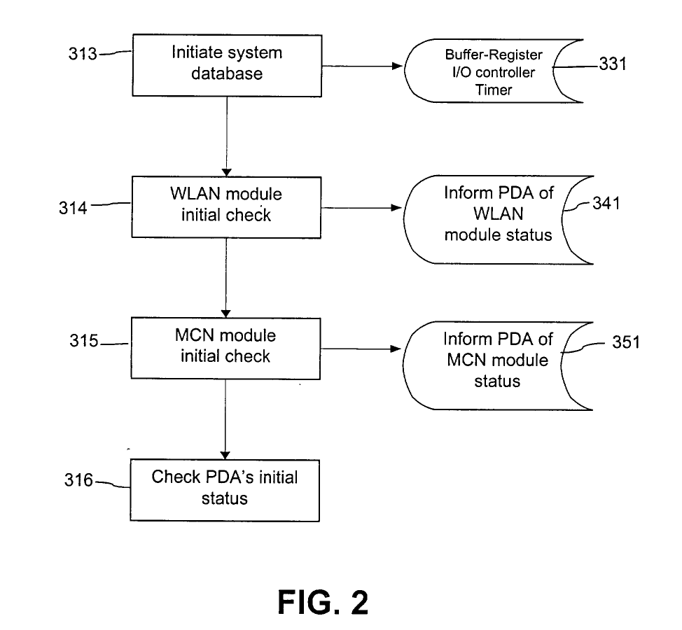

FIG. 2 illustrates the initial process of the PDA. When the PDA is turned on, the system database is firstly initiated (step 313). The process of initiating the system database includes steps of setting a buffer-register, an input/output controller, and a timer (step 331). Then, the initial status of the wireless local area network module is checked (step 314), and the PDA is informed of the status (step 341). Then, the initial status of the mobile communication network is checked (step 315), and the PDA is informed of the status (step 351). Moreover, the initial status of the PDA is checked (step 316). When the initial process is completed, the PDA is in a stand-by mode.

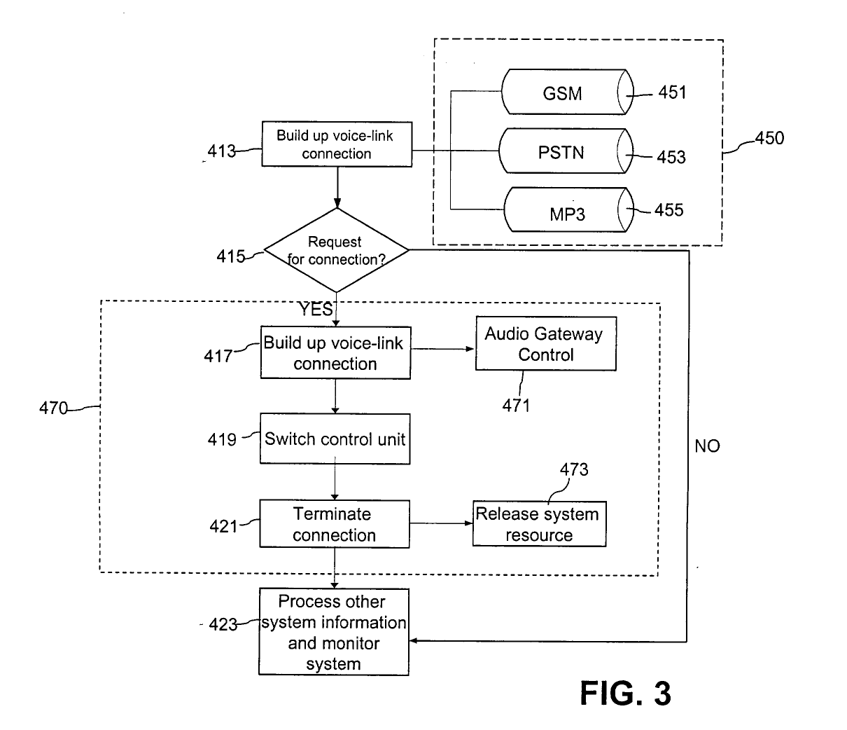

FIG. 3 illustrates a flow diagram of the PDA building up a voice-link connection. When a signal source 450 sends out a voice signal, the voice-link connection is initiated (step 413). The signal source 450 can be a mobile communication network module 451, a public switched telephone network (PSTN) 453, a MP3 player 455, and the like. Then, a request for building up the voice-link connection is sent to the PDA (step 415). When the request is rejected, the PDA processes other system information and monitors the system operation (step 423). When the request is accepted, the PDA enters a voice signal transfer procedure (block 470) and builds up the voice link (step 417). The step of building up the voice link includes the step of checking the status of the audio gateway (471). When the audio gateway is ready, a channel switch control unit controls the transmission of the voice signal (step 419). Then, the step of determining whether the voice link is terminated is performed (step 421). When the voice link is terminated, the PDA releases the system resource (step 473) and continues to process other system information and monitor the system operation (step 423) or returns to the stand-by mode.

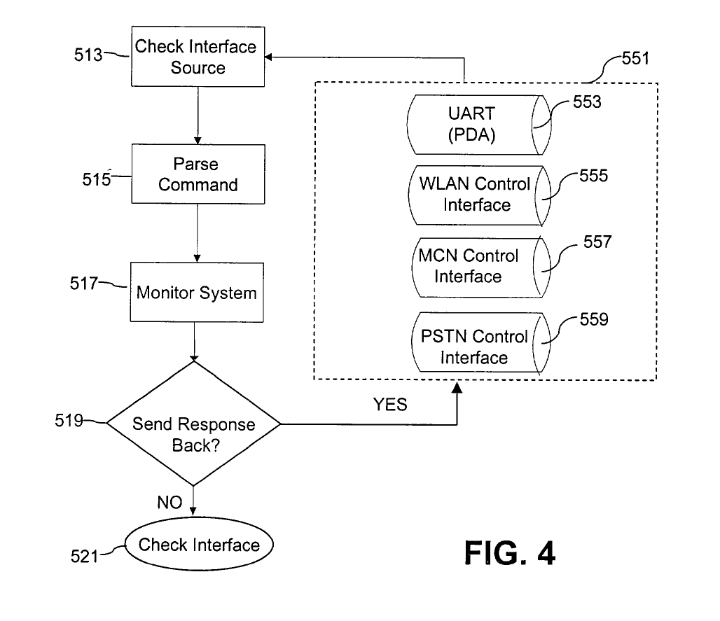

FIG. 4 illustrates a flow diagram of checking the interfaces of the PDA. The flow diagram starts with checking the resource of a transmission control interface 551 (step 513). The transmission control interface 551 can be a transceiver interface 553, a wireless local area network control interface 555, a mobile communication network control interface 557, a public switched telephone network control interface 559, and the like. Then, the steps of parsing commands (step 515), stating machine maintenance (step 517), and sending response back to the transmission control interface (step 519) are performed. When no response is sent back to the control interface, the interface checking procedure is repeated (step 521).

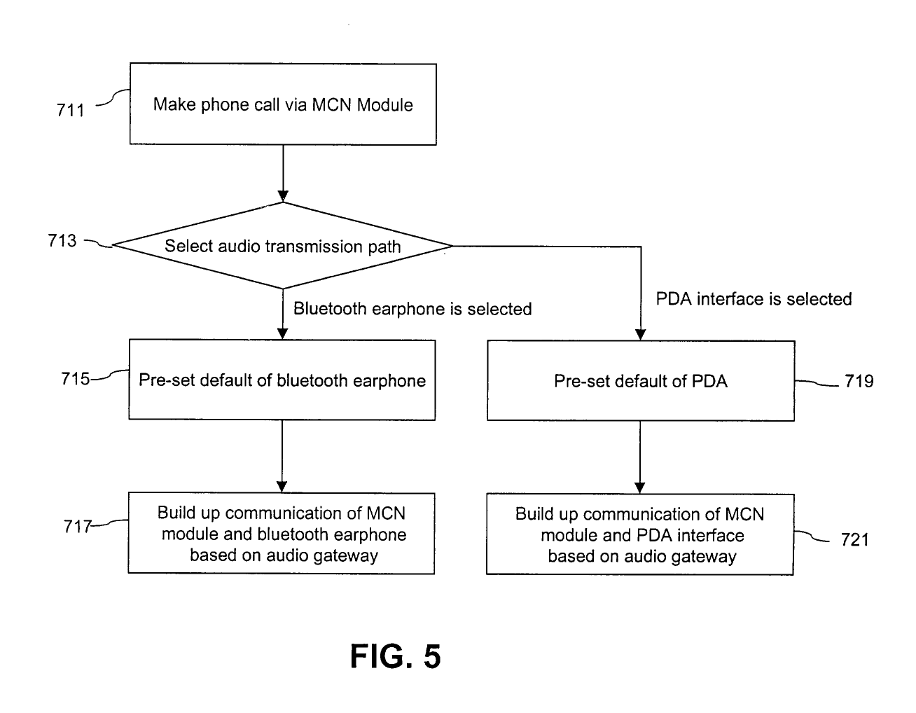

FIG. 5 illustrates a flow diagram of using the PDA to make a phone call in accordance with the present invention. In the step of 711, the user uses the PDA to make a phone call via the mobile communication network module. Then, an interface is selected to receive the phone call in step 713. When the wireless local area network module, such as a bluetooth module, is selected to receive the call, a step of pre-setting defaults of the blue tooth earphone is performed in step 715. The communication between the mobile communication module and the wireless local area network is built based on the audio gateway, and therefore the user receives the call with the bluetooth earphone in step 717. When the PDA is selected to receive the call, a step of pre-setting defaults of the PDA is performed in step 719. The communication between the mobile communication module and the PDA interface is built based on the audio gateway, and therefore the user receives the call with the PDA in step 721.

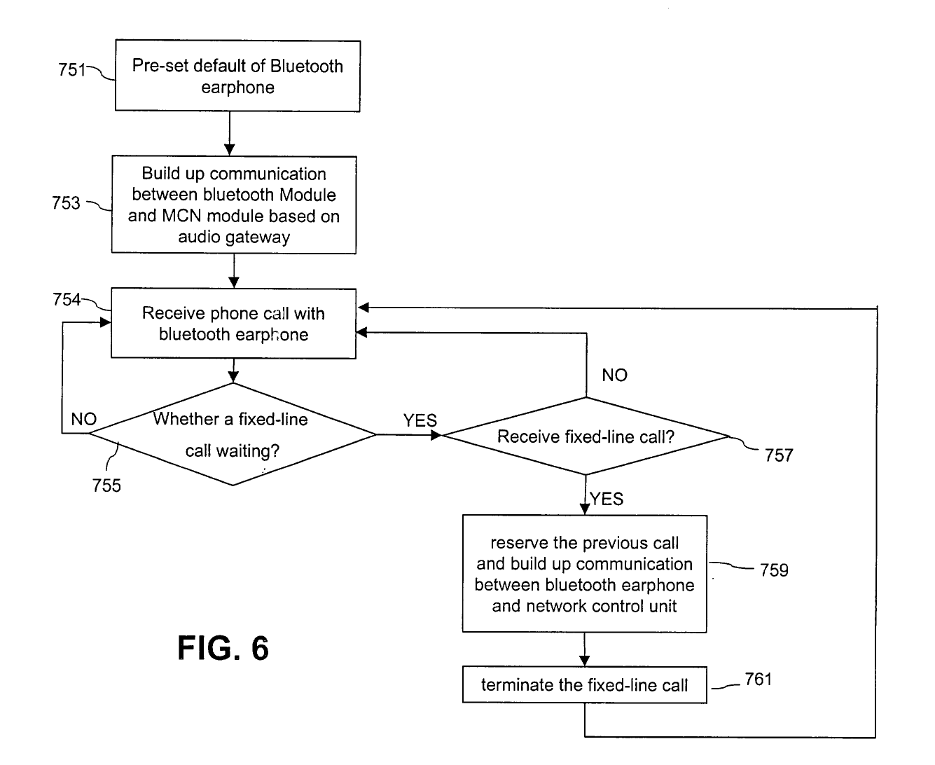

FIG. 6 illustrates a flow diagram of using the PDA to receive a phone call in accordance with the present invention. Firstly, a step of presetting defaults of the bluetooth earphone is performed in step 751. Then, the communication between the bluetooth module and the mobile communication network module is built based on the audio gateway in step 753. Then the bluetooth earphone is used to receive the call in step 754. Additionally, a step of determining whether a call is waiting is performed in step 755. When there is no call from the fixed-line network waiting, the step of receiving the call with the bluetooth earphone is continued (step 754).

When a call from the fixed-line network is waiting, a step of determining whether to accept the call is performed in step 757. When the call is declined, the step of receiving the call with the bluetooth earphone is continued (step 754). When the call is accepted, the previous call is reserved and a communication between the bluetooth earphone and the network control unit is built based on the audio gateway in step 759. When the user finished the call from the fixed-line network, the user can continue the first call (step 754).

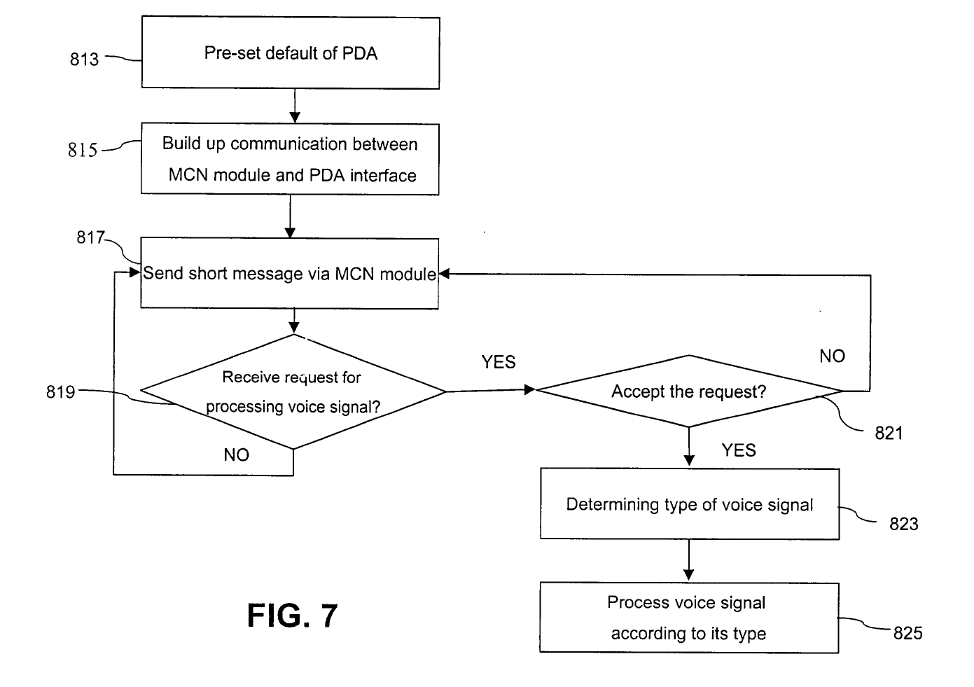

FIG. 7 illustrates a flow diagram of using the PDA to send a short message through the mobile communication network of the present invention. A step of pre-setting defaults of the PDA is performed in step 813. Then, the data communication between the mobile communication network module and the PDA interface is built in step 815. Next, a short message is sent via the mobile communication network module in step 817. Additionally, a step of determining whether receiving a request to process a voice signal is performed in step 819. For example, a request for call waiting or playing music in MP3 format is received. When no voice signal is received, the step of sending the short message is continued (step 817).

When a request to process a voice signal is received during the transmission of the data signal, a step of determining whether to accept the request is performed in step 821. When the request is declined, the step of sending the short message is continued (step 817). When the request is accepted, the step of sending the short message is interrupted and a step of determining the type of the voice signal is performed in step 823. Then, the voice signal is processed according to its type in step 825.

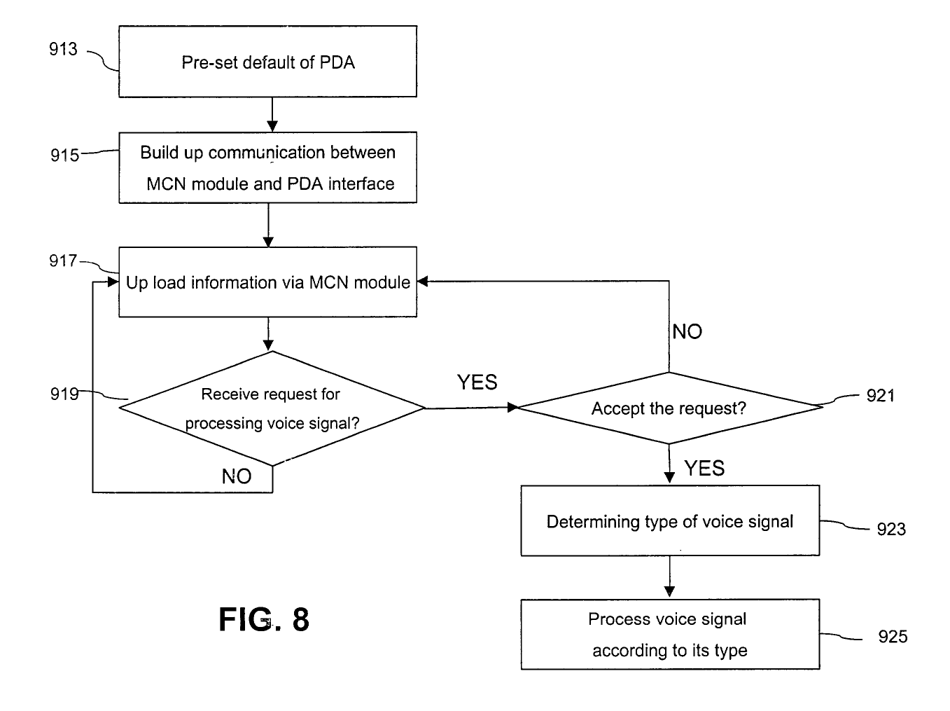

FIG. 8 illustrates a flow diagram of using the PDA to wirelessly access the internet in accordance with the present invention. Starting with the step 913, defaults of the PDA are pre-set. Then, the data communication between the mobile communication network module and the PDA interface is built in step 915. The data signal is transmitted via the mobile communication network to the internet in step 917. Additionally, a step of determining whether receiving a request to process a voice signal is performed in step 919. For example, a request for call waiting or playing MP3 music is received. When no voice signal is received, the step of sending the data signal is continued (step 917).

When a request to process a voice signal is received during the transmission of the data signal, a step of determining whether to accept the request is performed in step 921. When the request is declined, the step of sending the data signal is continued (step 917). When the request is accepted, the step of sending the data signal is interrupted and a step of determining the type of the voice signal is performed in step 923. Then, the voice signal is processed according to its type in step 925.

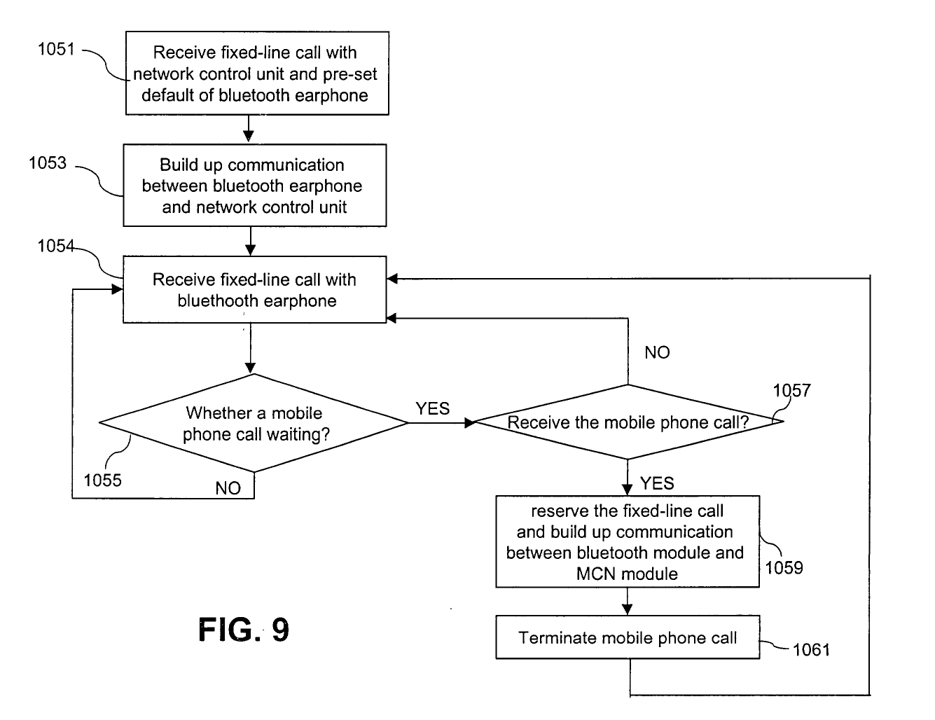

FIG. 9 illustrates a flow diagram of using the PDA to receive a call from the fixed-line network telephone in accordance with the present invention. Starting with step 1051, the network control unit is used to receive the call and the default is set to use the bluetooth earphone receiving the call. The communication between the bluetooth earphone and the network control unit is built based on the audio gateway in step 1053. Then, the bluetooth is used to receive the call in step 1054. Additionally, a step of determining whether a call from the mobile communication network module is waiting is performed in step 1055. When no call is waiting, the step of receiving the mobile call is continued (step 1054).

When a call from the mobile communication network is waiting during the transmission of the data signal, a step of determining whether to accept the call is performed in step 1057. When the request is declined, the step of receiving the fixed-line call is continued (step 1054). When the mobile call is accepted, the step of receiving the fixed-line call is reserved and a communication between the bluetooth earphone and the mobile communication network module is built in step 1059. When the mobile call is ended (step 1061), the step of receiving the fixed-line call is continued (step 1054).

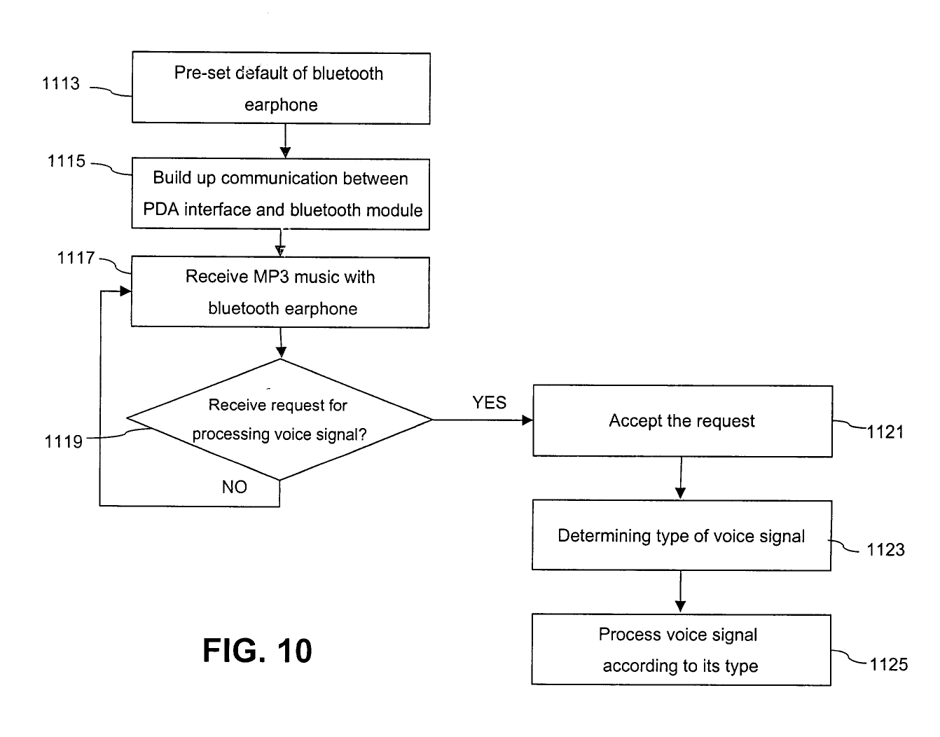

FIG. 10 illustrates a flow diagram of using the PDA to receive a music file in MP3 format in accordance with the present invention. Starting with the step 1113, defaults of the bluetooth earphone are pre-set. The data communication between the PDA interface and the bluetooth earphone is built in step 1115. Then, the bluetooth earphone is used to receive the music file in MP3 format (step 1117). Additionally, a step of determining whether to process a voice signal is performed in step 1119. For example, a call from the fixed-line network or from the mobile communication network is waiting. When no voice signal is received, the step of receiving the music file is continued (step 1117).

When a request to process a voice signal is received during the transmission of the music file, a step of processing the voice signal is performed in step 1121. Then, the step of determining the type of the voice signal is performed in step 1123. Then, the voice signal is processed according to its type in step 1125.

Although specific embodiments have been illustrated and described, it will be obvious to those skilled in the art that various modifications may be made without departing from what is intended to be limited solely by the appended claims.

What is claimed is:

1. An apparatus for integrating voice and data communications in a personal digital assistant (PDA), said apparatus respectively electrically coupling to a terminal device and a base station, said PDA including an interface, said apparatus comprising:
a wireless local area network module for transmitting a first voice signal and/or a first data signal to said terminal device and transmitting said first voice signal and/or said first data signal to said interface of said PDA via a bus;
a mobile communication network module for transmitting a second voice signal and/or a second data signal to said base station; and
an audio gateway for controlling transmission of said first voice signal and/or said second voice signal among said wireless local area network module, said mobile communication network module, and said interface.

2. The apparatus of claim 1 further comprising a transceiver for transmitting said first data signal and/or said second data signal to said interface of said PDA.

3. The apparatus of claim 2, wherein said transceiver comprises a universal asynchronous receiver/transmitter.

4. The apparatus of claim 2 further comprising a central control unit for processing said first data signal or said second data signal between said mobile communication network module and said transceiver.

5. The apparatus of claim 4, wherein said central control unit comprises a microcontroller.

6. The apparatus of claim 1, wherein said wireless local area network module comprises a bluetooth module.

7. The apparatus of claim 1, wherein said terminal device comprises a bluetooth earphone.

8. The apparatus of claim 1, wherein said terminal device comprises a bluetooth printer.

9. The apparatus of claim 1, wherein said terminal device comprises a personal computer with a bluetooth module.

10. The apparatus of claim 1, wherein said bus comprises a universal serial bus (USB).

11. The apparatus of claim 1, wherein said bus comprises a universal asynchronous receiver/transmitter (UART).

12. The apparatus of claim 1, wherein said bus comprises a PCMCIA (personal computer memory card international association) bus.

13. The apparatus of claim 1, wherein said mobile communication network module comprises a GSM (global system for mobile communication) module.

14. The apparatus of claim 1, wherein said mobile communication network module comprises a GPRS (general packet radio service) module.

15. The apparatus of claim 1, wherein said mobile communication network module comprises a CDMA (code-division multiple access) module.

16. The apparatus of claim 1 further comprising a network control unit interface for receiving a carrier signal.

17. The apparatus of claim 16, wherein said carrier signal is transmitted to said wireless local area network module via said audio gateway and to said terminal device via said wireless local area network module.

18. The apparatus of claim 17, wherein said wireless local area network module comprises a bluetooth module.

19. The apparatus of claim 17, wherein said terminal device comprises a bluetooth earphone.
